(19) United States
(12) Patent Application Publication
(10) Pub. No.: US 2001/0016605 A1
(43) Pub. Date: Aug. 23, 2001

(54) Use of a phenylurea derivative for controlling crown and root rot in beet

(76) Inventors: Heinz-Wilhelm Dehne, Bonn (DE); Irene Zens, Euskirchen (DE); Astrid Mauler-Machnik, Leichlingen (DE)

Correspondence Address: BAYER CORPORATION, PATENT DEPARTMENT, 100 BAYER ROAD, PITTSBURGH, PA, 15205, US

(21) Appl. No.: 09/757,809

(22) Filed: Jan. 10, 2001

(30) Foreign Application Priority Data
Jan. 17, 2000 (DE) 10001589.1

(51) Int. Cl. A01N 47/28

(52) U.S. Cl. 514/596

(57) ABSTRACT

N-4-Chlorobenzyl-N-cyclopentyl-N′-phenyl-urea of the formula

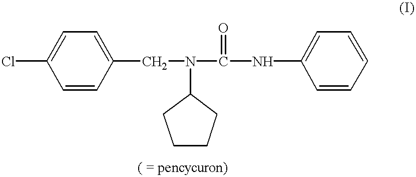

is highly suitable for controlling crown and root rot in beet.

Use of a phenylurea derivative for controlling crown and root rot in beet The present invention relates to the novel use of a known phenylurea derivative against crown and root rot in beet.

For some years, there have been epidemic-like occurrences of crown and root rot in beet, frequently causing serious damage to beet plants. However, hitherto no active compounds are known which are suitable for controlling this plant disease satisfactorily.

It is already known that N-4-chloro-benzyl-N-cyclopentyl-N′-phenylurea (=pencycuron) has fungicidal activity and can be used against various plant diseases (cf. DE-A 27 32 257).

Furthermore, it is already known that azoxystrobin and also hymexazol can be used for controlling numerous fungal infections in plants (cf. Pesticide Manual, 11^{th} Edition (1997), pages 70-72 and 689-690).

It has now been found that N4-chlorobenzyl-N-cyclopentyl-N′-phenyl-urea of the formula

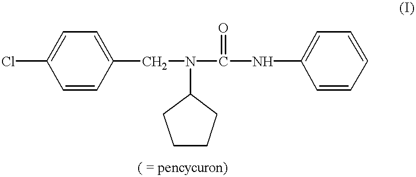

can be used with very good results for controlling crown and root rot in beet.

It is extremely surprising that N-4-chlorobenzyl-N-cyclopentyl-N′-phenyl-urea of the formula (I) is suitable for protecting plants against infection by crown and root rot, since hitherto no active compounds have been described which can be used for this purpose and allow satisfactory control of this disease.

The active compound of the formula (I) is already known (cf. DE-A 27 32 257).

The active compound of the formula (I) is highly suitable for controlling crown and root rot in beet plants, such as sugar beet, fodder beet and beetroot.

Crown and root rot in beet is a specific variant of the plant disease Rhizoctonia solani; namely Rhizoctonia solani AG 2-2 (anastomosis group 2-2).

The fact that the active compound to be used according to the invention is tolerated well by plants permits treatment of above-ground parts of plants, of propagation stock and seeds and of the soil. In particular, the active compound of the formula (I) can be used for protective control of crown and root rot.

The active compound to be used according to the invention can be converted into the customary formulations. Application is then carried out by applying these formulations or the use forms prepared therefrom, such as ready-to-use solutions, suspensions, wettable powders, pastes, soluble powders and granules. Application is carried out in a customary manner, for example by watering, spraying, atomizing, broadcasting, dusting, foaming, spreading, etc. It is furthermore possible to incorporate the preparation of active compounds into the soil. Particularly advantageously, it is also possible to treat the plant seed.

When employing the active compound which can be used according to the invention against crown and root rot in beet, the application rates can be varied within a relatively wide range, depending on the type of application. In the treatment of parts of plants, the active compound application rates are generally between 0.1 and 10,000 g/ha, preferably between 10 and 1000 g/ha. In the treatment of seed, the active compound application rates are generally between 0.001 and 50 g per kilogram of seed, preferably between 0.01 and 10 g per kilogram of seed. In the treatment of soil, the active compound application rates are generally between 0.1 and 10,000 g/ha preferably between 1 and 5000 g/ha.

The invention is illustrated by the examples below.

### EXAMPLE 1

Inhibition of the growth of Rhizoctonia solani AG 2-2 (anastomosis group 2-2)/protective

The substances are tested on suitable nutrient media for their activity against Rhizoctonia solani AG 2-2. To this end, the stated amount of active compound is in each case added to and intensively mixed with the stated amount of nutrient medium. The mixture in question is transferred into a culture vessel, inoculated with Rhizoctonia solani AG 2-2 and incubated at a suitable temperature. At certain intervals, the growth of the microorganism is assessed.

A nutrient medium of the following composition is used:

| | | |
|---|---|---|
| 39 | parts by weight of | potato glucose agar |
| 9 | parts by weight of | agar-agar |
| 10 | parts by weight of | peptone |
| 5 | parts by weight of | malt |

These components are dissolved in 1000 ml of distilled water and autoclaved at 121° C. for 30 minutes. The active compound at the stated concentration is then mixed with the nutrient medium. However, in all cases solvent and nutrient medium are present in the following weight ratio:

| | | |
|---|---|---|
| 2 | parts by weight of | solvent |
| 100 | parts by weight of | nutrient medium |

These mixtures are poured into Petri dishes having a diameter of 9 cm and a volume of 10 ml. Once the nutrient substrate has cooled and solidified, it is inoculated in the centre of the Petri dish with an inoculation piece having a diameter of 0.5 cm.

Evaluation is carried out after 2 to 14 days—depending on the rate of growth of the microorganism. The effect on the development of the culture is determined by comparing the individual test samples. 0% means an efficacy which corresponds to that of the untreated test variant. In contrast, an efficacy of 100% means complete inhibition of fungal growth. Accordingly, the efficacy of the fungicidally active compounds is demonstrated in relation to the growth of the untreated test variants (=control).

Active compounds, application rates and test results are shown in the table below.

TABLE 1
Inhibition of the growth of Rhizoctonia solani AG 2-2/protective

| | Active compound appli- | |
|---|---|---|
| Active compound | cation rate in ppm | Efficacy in % |
| — | 0 | 0 |
| (control) | | |
| According to the | 0.1 | 70 |
| invention: | 1 | 98 |
| pencycuron | 10 | 100 |
| | 100 | 100 |
| Comparative substances: | 0.1 | 45 |
| azoxystrobin | 1 | 48 |
| | 10 | 59 |
| | 100 | 64 |
| hymexazol | 0.1 | 7 |
| | 1 | 5 |
| | 10 | 8 |
| | 100 | 35 |

1. Use of N-4-chlorobenzyl-N-cyclopentyl-N′-phenyl-urea of the formula 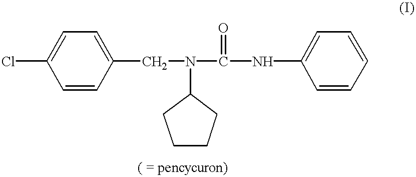
for controlling crown and root rot in beet.
